(19) United States
(12) Patent Application Publication
(10) Pub. No.: US 2009/0304368 A1
(43) Pub. Date: Dec. 10, 2009

(54) COMMUTATOR MOTOR COMPRISING A DEVICE FOR CONTROLLING THE ANGULAR POSITION AND ROTATIONAL SPEED OF THE ARMATURE THEREOF

(76) Inventor: Nicolas Boissonnade, Thouars (FR)

Correspondence Address: W. EDWARD RAMAGE, COMMERCE CENTER SUITE 1000, 211 COMMERCE ST, NASHVILLE, TN, 37201, US

(21) Appl. No.: 11/577,985

(22) PCT Filed: Oct. 21, 2005
(86) PCT No.: PCT/FR2005/002618

§ 371 Date: Jul. 28, 2009

(30) Foreign Application Priority Data
Oct. 25, 2004 (FR) 0411335

(51) Int. Cl. H02P 7/28; H02K 23/66; H02K 13/00

(52) U.S. Cl. 388/800; 310/68 B; 310/219

(57) ABSTRACT

An electric commutator motor comprising a housing and a shaft which is solidly connected to a rotor. The housing comprises a stator and supply brushes which can be connected to an electric power source. The rotor is solidly connected to a commutator with bars, and comprises a set of wound turns, the ends of which are connected to two successive bars of the commutator. The housing comprises at least one additional brush which is positioned close to at least one of the supply brushes, known as the monitor brush, at a distance less than the width of a bar. The additional brush and the monitor brush are of the same thickness and are disposed symmetrically in relation to a diametrical plane of the rotor. The additional brush is connected electrically to a means for counting the pulses generated directly on the additional brush when the monitor brush leaves a bar of the commutator.

### FIELD OF THE INVENTION

The invention relates to commutator motors equipped with a device for controlling the angular position of their armature, also called a rotor. It can relate to both motors and actuators placed on board motor vehicles as well as more powerful electric motors, such as rolling mill motors.

### BACKGROUND OF THE INVENTION

Detecting the angular position of an electric motor, together with controlling the direction of rotation, makes it possible to control the movement of moving parts activated by such motors, e.g., parts placed on board a motor vehicle such as an electrically adjustable window, a windshield wiper blade, a sun roof, an outside rearview mirror, a gas inlet valve, and the like. It also makes it possible to control and regulate the rotational speed of the electric motor, the latter being, for example, the fan motor of an air conditioning device or the powerful motor of a rolling mill. In the latter case, regulating the rotational speed of the rolls of the rolling mill is essential to controlling the dimensional quality and surface appearance of the rolled slabs or sheets.

The electric motors used to move on-board parts are direct current motors, which comprise a frame and a shaft integral with the rotor. The frame includes the stator or field winding (magnetic field source), typically a set of permanent magnets or a stationary winding creating a magnetic field, and sliding electrical contacts capable of being connected to an electrical power source. Wire conductors connected to the bars of a commutator integral with the rotor are wound round the rotor, also called an armature. In order to electrically connect the windings of the rotor, the sliding electrical contacts, typically brushes made of a carbonaceous material, are pressed against the surface of the commutator so that, when the rotor rotates, they are successively placed in contact with each of the commutator bars.

By rubbing against the commutator bars, the brushes induce a current in the wire conductor connecting the two bars in contact with said brushes. This current, combined with the magnetic flux of the field winding, produces a force which drives the rotor wire in rotation (Laplace force). The bars, separated from each other by an insulator, are arranged such that the portion of the wire conductor passing through a magnetic flux area of a given polarity is traversed by a constant direction current despite rotation. This arrangement is made possible thanks to a reversal in the direction of the current (switching) that occurs when the brushes pass from one bar to another, a passage that coincides with the passage of a portion of the wire conductor that connects the two bars in contact with said brushes from a given area of magnetic polarity to the area of opposite polarity. Owing to the reversal in the direction of the current in said wire portion, the latter, having reached the area of opposite magnetic polarity, continues to be subjected to a tangential force of the same direction.

During switching, more precisely when a bar moves out of contact with a brush, a more or less abrupt overvoltage appears between the brush and said bar. This overvoltage can involve a spark or else an electric arc, which has the disadvantages of causing degradation of the brush due to electrical discharge machining, environmental disturbance due to electromagnetic radiation, and the creation of overvoltage in the power supply circuit.

These disadvantages are mitigated, in particular, by choosing a particularly well-suited material for the brushes. For example, for small electric motors placed on board a motor vehicle, this material may be a sintered metallo-graphitic grade prepared from a mixture of powders composed substantially of natural graphite and copper. A grade such as this has low electrical resistivity, a low coefficient of friction, good refractory properties and a good ability to avoid seizing and welding on the commutator. This is mitigated also by carrying out a particular spatial arrangement of the windings and their connections to the bars. In general, the wire conductor corresponds to a set of coils wound at precise locations of the rotor and whose ends are connected to two successive bars: the armature can thus be represented by a long wire separated into segments attached to one another by the commutator bars. On the other hand, the brush has a width greater than the space separating two bars. In this way, the switching is carried out in two phases since, when the brush comes into contact with the next bar, the loop associated with the two successive bars is first short-circuited. Thus, switching from one commutator bar to another is accomplished by the short-circuiting, across the bar, of a winding wound at a precise area of the rotor. Due to this short circuit, which tends to stop the current in said winding, the current reversal is somewhat less abrupt. However, due to the electromagnetic energy stored in the winding, the current in said winding cannot be reversed or even stopped rapidly without significant overvoltage occurring between the ends of the winding.

In such motors, various techniques are known for producing an electrical signal representative of the speed of the motor or its angular position. A signal such as this enables automatic control of the rotational speed or control of the angular position of the motor. These techniques are based substantially on a measurement of the variations in the magnetic field of the commutator, using a Hall effect probe and a magnetic ring with an often multipolar magnetisation and generally placed near the commutator, or on a measurement of the supply voltage ripples due to the switching of the commutator bars, described, for example, in U.S. Pat. No. 6,144,179 (“ripple” effect) or else the addition of outside sensors requiring conversion of the commutator and/or the power supply.

The application DE 4229045 discloses the addition of a scanning track parallel to the commutator, connected to at least one blade of the commutator but having a circumferential length greater than it. An additional brush is assigned to this scanning track and, after measurement of the voltage differences between the scanning track and the blades and then analysis of their ripples, makes it possible to estimate the rotational speed and angular position. In the application EP 0753931, several additional brushes are introduced, which are applied to the commutator. The voltage collected by these additional brushes is processed by an electronic circuit which analyses the ripples thereof. The applications EP 0433733 and FR 2,791,486 draw on analysis of the secondary current passing through the motor. EP 0433733 analyses the variations introduced by the counter-electromotive force generated in the armature. In the patent application FR 2,791,486, a third brush is introduced, which is electrically insulated and of a width greater than the space contained between two successive bars. When straddling two bars, this third brush short-circuits the coil associated with these bars, the modification of the currents and magnetic fields induced which results from this creating pulses in the electric current passing through the motor, the frequency of which is proportional to the rotational speed of the motor.

Each of these sensing arrangements has disadvantages, in terms of additional costs for the motor: loss of efficiency, loss of precision (particularly with the Hall effect system where only one pulse is obtained per revolution), the necessity of introducing specific sensors, of modifying the surface of the commutator (e.g., by creating an additional scanning track), and/or also connecting electronic processing circuits intended to provide the desired information. Furthermore, whichever solution is chosen, the interpretation of the signals read from an electric motor is always difficult, given that the parasitic signals linked to the formation of arcs, to polar switching disturbances and to modifications of the currents and fields induced, are superimposed over the useful signals.

Accordingly, what is needed is a solution making it possible to measure the angular position of the axis associated with the rotor of an electric commutator motor, which does not require the introduction of a complex or costly device and which delivers easy-to-interpret useful signals.

### SUMMARY OF THE INVENTION

In one exemplary embodiment, the invention comprises an electric commutator motor including a frame and a shaft integral with a rotor, said frame including a stator and power supply brushes capable of being connected to an electric power supply source, the rotor being integral with a commutator with bars and including a set of wound coils the ends of which are connected to two successive bars of said commutator, said frame including at least one additional brush situated in proximity to one of the power supply brushes, that will be referred to hereinafter as “follow-up brush,” at a distance less than the width of one bar, said additional brush being connected to an electrical circuit including a means of measuring electrical voltage, characterised in that said additional brush and said follow-up brush have a substantially equal width and are arranged symmetrically in relation to a diametral plane of the rotor.

In this way, the additional brush is at least periodically in contact with the power supply brush referred to as “follow-up brush,” by way of a bar. It is also connected to an electrical circuit that includes a voltage measuring means which makes it possible to continuously know the voltage on said additional brush. The circuit is arranged in such a way that the voltage on the additional brush is known in relation to another voltage: a constant reference voltage (ground, for example) or else that of one of the power supply brushes (the follow-up brush, for example). The electrical circuit also advantageously includes a signal processing means using said voltage measured on the additional brush and making it possible to count the current pulses generated in said electrical circuit to which the additional brush is connected, in particular when the follow-up brush leaves a bar of the commutator.

The device equipping the motor according to one embodiment of the invention is simple and makes it possible to measure the angular position of the motor by counting the commutator bars. The principle followed consists in using the alternation of the different electrical signals transmitted on the additional brush and that appear, on the one hand, when the follow-up power supply brush and the additional brush are in contact by way of a bar and, on the other hand, when a bar loses contact with the follow-up brush. As a matter of fact, an overvoltage appears when a bar leaves a power supply brush. This overvoltage involves a current pulse generated in the electrical circuit to which the additional brush is connected. It is this current pulse, for example, which, after transformation, filtering and conversion, makes it possible to count the bars of the commutator and to consequently measure the position and/or to control the speed of the motor. Within the framework of this invention, the power supply brush is referred to as the “follow-up brush,” since an additional brush is assigned to it, which is placed in proximity thereto and which, when associated with a measuring circuit, makes it possible to continuously follow the electrical signals transmitted and, in particular, the pulses generated when a bar leaves the follow-up brush.

The additional brush is placed in proximity to the follow-up brush. The additional brush and the follow-up brush are distant from each other by a distance less than the width of a bar, whereby the additional brush is periodically at the same potential as the follow-up brush by means of a common bar.

The additional brush can be placed after or before the latter, in relation to the direction of rotation of the motor.

When it is placed after the follow-up brush (downstream), a commutator bar first encounters the power supply brush and then the additional brush. When it leaves the follow-up brush, it is still in contact with the additional brush. The pulse corresponds substantially to the discharge of the inductance of the portion of the induced winding that is connected to the bar still in contact with the power supply brush and to the one that has just lost contact with said brush.

When it is placed before the follow-up brush (upstream), a commutator bar first encounters the additional brush and then the follow-up brush. The pulse results from the transition from a state where the two brushes are on the same bar and where the difference in potential between the brushes is consequently zero, to a state where the two brushes are on different bars and where the difference in potential between the brushes corresponds substantially to the drop in potential generated by the induced current that passes through the coil connected to the two aforesaid bars. The pulse corresponds substantially to the passing of a current through the segment of the armature that is connected to the bar still in contact with the power supply brush and with the one that has just lost contact with said brush. In this case, the signal is weaker, but remains exploitable.

The additional brush and the follow-up brush could have different widths: the follow-up brush is a power supply brush whose width must be as close as possible to that of the other power supply brush or brushes and the additional brush could be narrower since it essentially serves to collect the pulse created when a bar leaves the follow-up brush. However, according to the invention, the additional brush and the follow-up brush have a substantially equal width and are arranged symmetrically in relation to a diametral plane of the rotor, so as to be able to play interchangeable roles regardless of the direction of rotation of the motor.

The choice of the direction of rotation is easily made, e.g., with the aid of transistors or a properly connected relay. The additional brush then becomes the follow-up brush and the follow-up brush, to which the circuit including the voltage measuring means and the signal processing means is also connected, becomes the additional brush. The two brushes are then simultaneously connected to the power supply and to the measuring and signal processing circuit, so that the system can be reversible (operation in both directions of rotation). In a configuration such as this, the measuring and signal processing circuit connects the follow-up brush and the additional brush, which for this reason is electrically uninsulated permanently.

Furthermore, a configuration such as this improves the electromagnetic compatibility of the motor, in particular when the additional brush is placed downstream from the follow-up brush (i.e., after it in the direction of rotation). The follow-up brush and the additional brush are connected by said electrical circuit and, when the follow-up brush leaves a bar, which however remains in contact with the additional brush, a portion of the discharge current of the winding associated with these two bars is diverted towards this electrical circuit, which reduces the amplitude of the overvoltage.

According to an exemplary embodiment of the invention, the additional brush and the follow-up brush have a substantially equal width. The latter must be sufficient enough for the brushes to resist wear as well as the other brushes. However, it is recommended that the overall width of the assembly formed by the additional brush and the follow-up brush not be too significant, because the efficiency of the motor decreases with the number of segments of the winding that are short-circuited, and this is all the more significant to the extent that the follow-up brush and additional brush are wider. As much as possible, an overall width is sought for the assembly formed by the additional brush and follow-up brush which is as close as possible to the width of the power supply brush or brushes. Typically, this overall width should not exceed the minimum width of the power supply brushes other than the follow-up brush (in general all of these brushes have the same width) plus the width of one bar. In this way, a maximum of two bars are short-circuited.

The space separating the follow-up brush and the additional brush must be less than the width of one bar in order for there to be shared potential and the possibility of discharge in the additional brush, at each passage of a bar, as soon as the bar leaves the power supply brush. For obvious reasons involving the overall dimensions and efficiency of the motor, the space separating the follow-up brush and the additional brush must be as small as possible, but sufficiently large to prevent the creation of untimely arcs between them. This distance depends, in particular, on the material used for the brushes and the insulation used (air, paper, plastic, etc.) and can vary between a few hundredths of a millimetre and a few millimetres. Typically, it is a few tenths of a millimetre for a 12-volt direct-current motor.

The additional brush is electrically connected to a voltage measuring means and to an electrical signal processing means. The electrical signal to be processed is constructed from the voltage on the additional brush. For example, as a signal, it is possible to take the difference in potential between the additional brush and ground. But, preferably, the additional brush and the follow-up brush being usable interchangeably, regardless of the direction of rotation of the motor, the processed and transformed signal uses the difference in potential between the follow-up brush and the additional brush.

The number and spatial arrangement of the brushes depends on the multipolarity of the electric motor. The invention can be applied to any type of multipolar direct-current motor, typically with 2, 4 or 6 poles, whether it involves a small motor placed on board a motor vehicle or a rolling mill motor. The invention will be illustrated below by one particular embodiment: a bipolar direct-current motor, representative of motors for equipment placed on board motor vehicles.

In such a motor, the power supply brushes are conventionally arranged along the circumference of the motor so that they are diametrically opposite one another. This arrangement enables a systematic distribution of the currents on each of the coil winding paths. The neutral line of the motor corresponds to the boundary between these areas, i.e., to the diametrically opposite locations where the magnetic polarity changes signs. It is at this location that the current must be reversed and the brushes must be placed as close as possible to the neutral line.

The bipolar direct-current motor produced according to this embodiment of the invention has an additional brush and a follow-up brush that are symmetrical in relation to the diametral plane of the rotor, the latter coinciding with the plane of symmetry of the other power supply brush. In this preferred embodiment, the width of the power supply brush or, more generally speaking, the maximum width of the power supply brushes other than the follow-up brush, and the overall width of the group consisting of the follow-up brush and the additional brush, is less than the width of one bar plus two interbars (spaces separating the bars).

If the additional brush is placed downstream from the follow-up brush and if a bar leaves the follow-up brush, a discharge current appears in the winding segment of the armature that is connected to the bar still in contact with the follow-up brush and with the one that has lost contact with said follow-up brush. This results in an abrupt variation in voltage on the additional brush, and consequently in an abrupt variation in the difference in potential between the additional brush and the follow-up brush. However, the follow-up brush and the additional brush being connected by a resistive circuit, the electromagnetic disturbances of the motor are lessened.

If the additional brush is placed upstream from the follow-up brush and if a bar leaves the follow-up brush, a pulse of weaker amplitude is picked up in the measuring circuit. The ripples picked up are sufficient to enable counting of the bars, after filtration and conversion.

Another object of the invention is a method for controlling the angular position and rotational speed of the rotor of a commutator motor, typically a direct-current motor, consisting in counting the number of bars of the commutator passing in front of a fixed point, characterised in that the fixed point chosen is one of the power supply brushes, referred to as a follow-up brush, in that an additional brush is placed in proximity to said follow-up brush, at a distance less than the width of one bar and in that the voltage on said additional brush is measured continuously. In order to carry out this measurement continuously, the additional brush is connected to a circuit including at least one voltage measuring means and one electrical signal processing means using said voltage. The signal is processed in such a way that it is possible to count the pulses generated each time a bar of the commutator leaves the follow-up brush.

The additional brush can be placed after or before the follow-up brush, in relation to the direction of rotation of the motor. If the additional brush is placed downstream from the follow-up brush and if a bar leaves the follow-up brush, a discharge current appears in the segment of the armature that is connected to the bar still in contact with said follow-up brush and with the one that loses contact with said follow-up brush.

The processing means is advantageously an electronic circuit that uses the continuously measured voltage on the additional brush in order to generate a signal, and that makes it possible to transform, filter and convert said signal into a squarewave signal. In this way, it makes it possible to count the bars of the commutator and to consequently control the angular position of the motor and/or its rotational speed.

According to an exemplary embodiment of the invention, the additional brush and the follow-up brush have a substantially equal width and are arranged symmetrically in relation to a diametral plane of the rotor, so as to be able to play interchangeable roles regardless of the direction of rotation of the motor.

The signal collected on the additional brush is compared to the power supply voltage of the follow-up brush. In this way, the difference in potential between the follow-up brush and the additional brush is measured. This difference in potential is then filtered so as to eliminate the high-frequency disturbances therefrom. An operational amplifier-based comparator can be used to generate a squarewave signal. The filtering of the signal, as well as the reference voltage for switching the operational amplifier, and consequently the creation of the squarewave signal, are determined with respect to the motor. This choice makes it possible to operate the system even when the motor stops, i.e., when it is no longer powered but still driven in rotation by its inertia.

It is possible, for example, to filter only the high frequencies superimposed over the signal or to filter the signal so as to have nothing more than the fundamental frequency thereof. These means are easy to implement and it is very easy to generate a squarewave signal from these means. Furthermore, it is easily possible to imagine the implementation of any system making it possible to modify the cyclic ratio, amplitude, etc., of the squarewave signal.

The reference voltage for switching the operational amplifier is, for example, created from the signal itself, by filtering it. This operation enables operation of the system even when the motor stops. Consequently, it would be possible to measure the position of a motor operating as a generator. Finally, a monostable assembly can possibly be added in order to regulate the cyclic ratio of the squarewave signal generated.

Another object of the invention is a device for controlling the angular position and rotational speed of the commutator motor, including brush-holders equipped with brushes capable of being connected to an outside electrical circuit and including an additional brush, characterised in that said additional brush is placed next to one of said brushes capable of being connected to an outside electrical circuit, referred to as a follow-up brush, at a distance less than the width of one bar of the commutator of said motor and in that said additional brush is connected to an electrical circuit including a voltage measuring means and an electrical signal processing means using the voltage thus measured and making it possible to count the pulses generated when a bar leaves the follow-up brush.

The brushes capable of being connected to an outside electrical circuit are generally the power supply brushes capable of being connected to the power supply circuit. But, as will be seen further on, the system can operate in the same way when the motor is not powered, i.e., when it operates as a generator. In this case, the outside circuit can be an electrical circuit powered by the generator.

The additional brush can be placed after or before the follow-up brush, in relation to the direction of rotation of the rotor. If the additional brush is placed downstream from the follow-up brush and if a bar leaves the follow-up brush, a discharge current appears in the segment of the armature that is connected to the bar still in contact with said follow-up brush and with the one that loses contact with said follow-up brush.

The additional brush is connected to an electrical circuit that includes a voltage measuring means and an electrical signal processing means, typically an electronic circuit, using the measured voltage and making it possible to count the pulses generated when a bar leaves the follow-up brush. With the aid of an appropriate electronic circuit, the pulses are shaped, filtered and converted so as to be able to count the bars of the commutator.

According to another embodiment of the invention, the additional brush and the follow-up brush have a substantially equal width and are arranged symmetrically in relation to a diametral plane of the rotor, so as to be able to play interchangeable roles, regardless of the direction of rotation of the motor. The device enabling reversal of the direction of rotation can be made very simply, for example, from transistors or relays.

The electronic circuit makes it possible to process the signal collected on the additional brush by comparing the latter to the power supply voltage of the follow-up brush. In this way, the difference in potential between the follow-up brush and the additional brush is measured and this difference in potential is then filtered so as to eliminate the high-frequency disturbances therefrom. The filtering of the signal, as well as the reference voltage for switching the operational amplifier, and consequently the creation of the squarewave signal, are determined with respect to the electric motor concerned.

This electronic circuit must be able to be operational regardless of the direction of rotation of the motor. The solutions currently used for reversing the direction of rotation of the motor can be applied, only the wiring for the transistors or relays is modified slightly, which does not involve any additional production cost.

Using a device such as this, the system can be operated even when the motor stops, i.e., when it is no longer powered, but still driven in rotation by its inertia. It is therefore also possible to control the angular position of the rotor when the motor operates as a generator, i.e., when, in the absence of a power supply and if the rotor is driven in rotation, this system also makes it possible to count the pulses generated by the passing of the bars. A device such as this can thus be used in displacement transducers, for example.

### BRIEF DESCRIPTION OF THE FIGURES

FIGS. 1a, 1b and 1c are schematic illustrations showing the respective positions of certain portions of the rotor (sections of the winding and/or bars of the commutator) and of certain portions connected to the frame of the motor (field poles, brushes) according to the prior art.

FIG. 1a is a schematic illustration of a cross section of a commutator and brushes of a conventional commutator motor including 8 bars according to the prior art.

FIG. 1b shows a cylindrical projection of the field winding, brushes, winding and commutator according to the prior art.

FIG. 1c shows a cylindrical projection of the commutator and brushes, the loops of the coil sections, for greater clarity, being indicated by a symbol without any spatial significance. A flap winding has been chosen. Other types of windings could have been chosen (e.g., wave windings) to which the invention can also be applied, because the operating principle remains the same.

FIG. 2 is a schematic illustration of a cross section of the commutator and the brushes of a commutator motor according to an embodiment of the invention.

FIGS. 3a, 3b and 3c show (schematically for the coil sections) a cylindrical projection of the commutator and the brushes of a commutator motor according to an embodiment of the invention, in three different spatial configurations.

FIG. 4 schematically shows the evolution over time of the difference in voltage measured between the power supply brush and the additional brush.

### DETAILED DESCRIPTION OF EXEMPLARY EMBODIMENTS

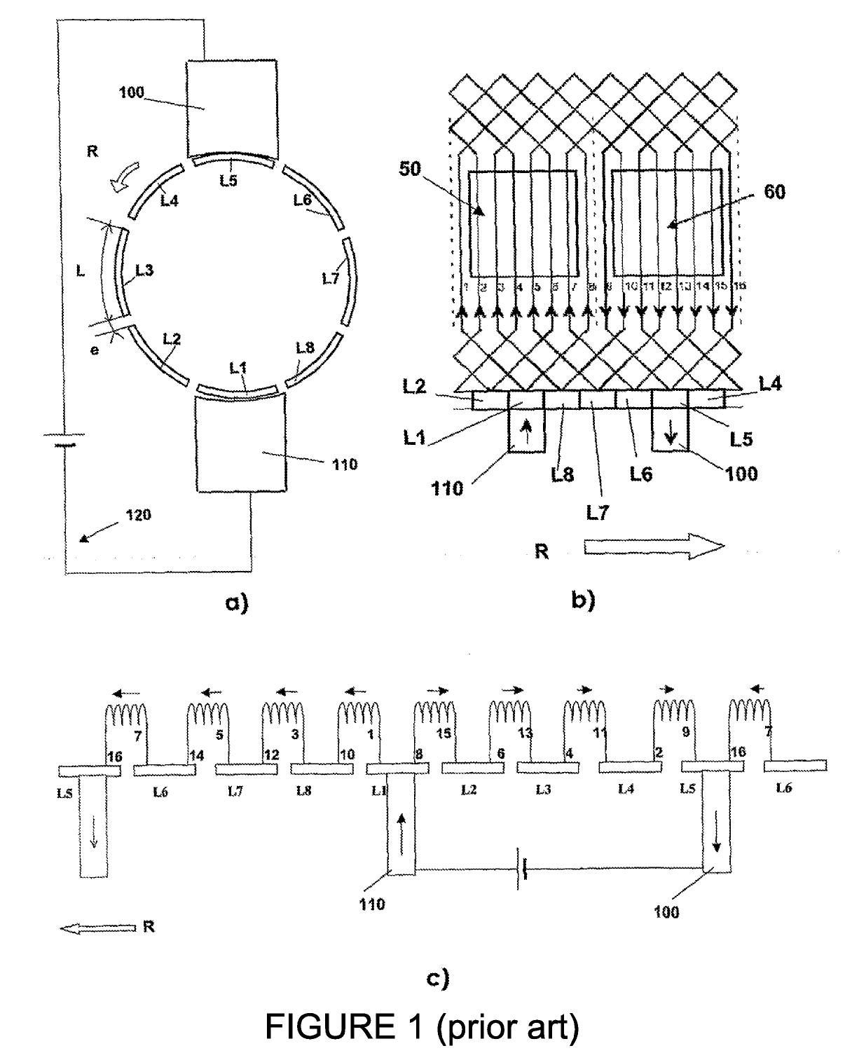

FIG. 1a shows an electric commutator motor including a frame and a shaft integral with a rotor, said frame including a stator and the power supply brushes 100 and 110 connected to an electrical power supply via the circuit 120. The rotor is integral with a commutator equipped here with 8 bars (L1, L2, L3, L4, L5, L6, L7, L8) and including a set of coiled loops whose ends are connected to two successive bars of the commutator. As can be seen in FIG. 1c, these loops are the segments of the same winding, joined together by means of the bars. In FIG. 1b, it can be seen that the segments are coiled around the rotor so that the rising portions through which a rising current passes (1, 2, 3, 4, 5, 6, 7, and 8, respectively) and the descending portions through which a descending current passes (9, 10, 11, 12, 13, 14, and 15, respectively) are situated in two polarity zones (50 and 60) through each of which a magnetic field of the opposite direction passes.

The portions 1, 16, 8, and 9 are situated in proximity to the neutral line: during rotation R, they pass from one polarity zone to the other and, during the course of this passage, are the object of a reversal of current via switching of the brushes on the bars.

In general, the brush is slightly wider than the bar, its width E typically being equal to the sum of the width L of the bar and 2 interbars e. This preferred geometric condition (E=L+2e) facilitates the switching of the current in the armature.

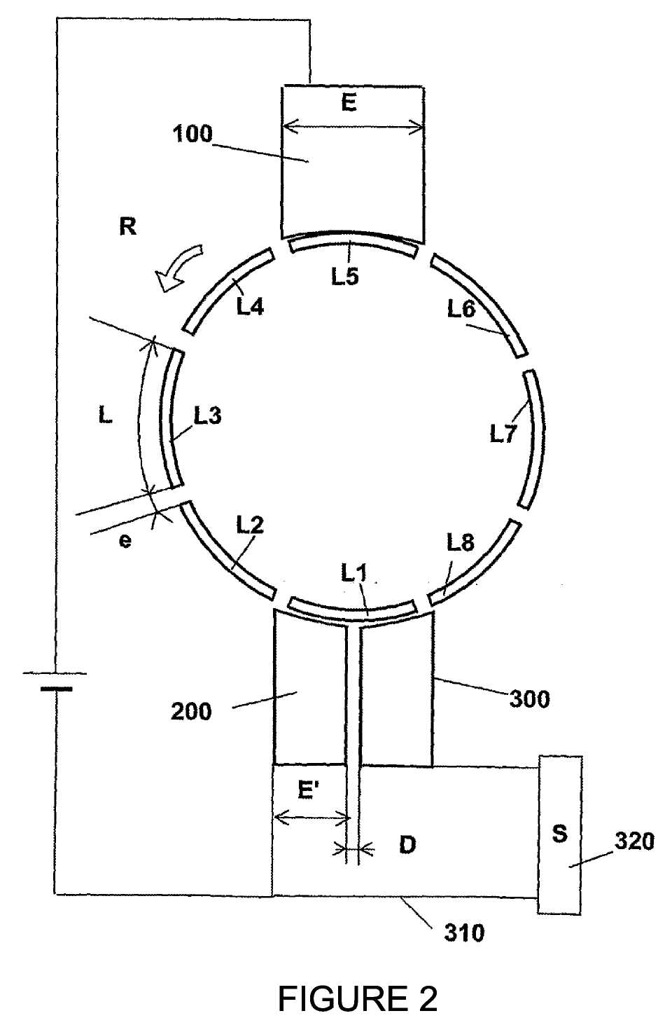

FIG. 2 is a schematic illustration of the bars of the commutator and the brushes according to an exemplary embodiment of the invention: the commutator is identical to the commutator of the conventional direct-current motor shown in FIG. 1: the invention does not require modification of the rotor. One of the two power supply brushes, the brush 100, is not modified, the other is replaced by a pair of brushes, the follow-up brush 200 performing the electrical power supply function and the additional brush 300 is placed in proximity to the follow-up brush 200, at a distance D less than the width L of a bar, and is situated after it in the direction of rotation R of the motor. The additional brush 300 is electrically connected to the follow-up brush 200 via a circuit 310 including a measuring and electrical signal S processing device 320.

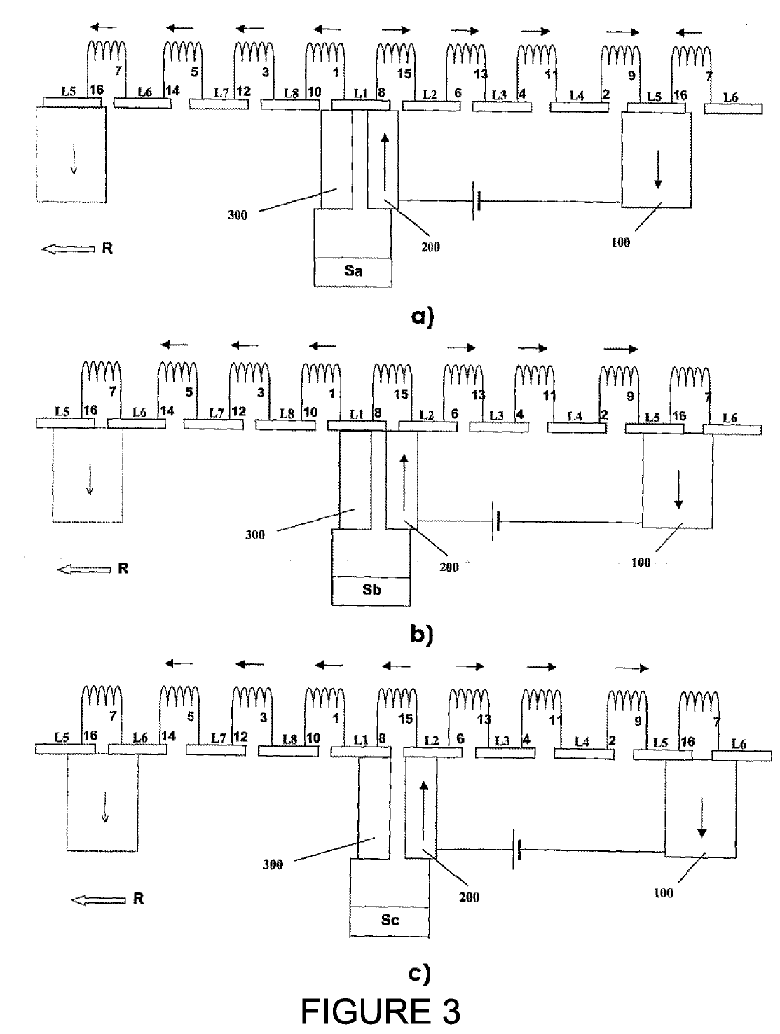

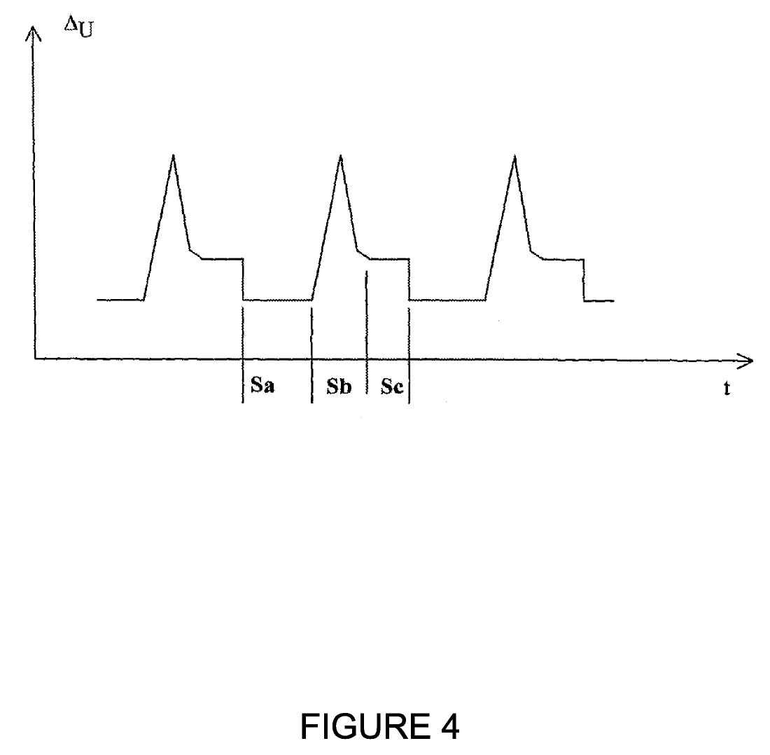

FIGS. 2 and 3a show the bars and brushes in a first configuration, similar to the one encountered in the conventional case shown in FIG. 1c. The power supply brush 100 supplies the armature by means of a first bar L5, diametrically opposite to the bar L1, which is in contact with the other power supply brush 200 and also with the additional brush 300. The additional brush 300 and the follow-up brush 200 being at the same potential as the bar L1, the measured difference in potential equals 0V. The re-centred signal Sa is equal to half the voltages applied to the follow-up brush and the additional brush. In this case, it is equal here to half the power supply voltage of the motor, i.e., 6V for a 12V motor.

As concerns this exemplary embodiment, the power supply brush 200 and the additional brush 300 have the same width E′, chosen such that 2*E′+D=E.

The additional brush 300 and the follow-up brush 200 have the same thickness E′ and are arranged symmetrically so as to be able to play interchangeable roles, regardless of the direction of rotation of the motor: if the polarity of the power supply terminal is reversed in order to reverse rotation, it suffices to connect the reversed pole to the other brush; in this way, the additional brush 300 becomes the power supply brush and the power supply brush 200 becomes the additional brush onto which the measuring and signal processing circuit is connected.

In FIG. 3b, it is seen that, by continuing rotation, the bar L2 arrives in contact with the power supply brush 200, which results in the short-circuiting of the segment of the winding including the portions 8 and 15. The brush 100 also short-circuits the segment including the portions 7 and 16 by placing the bars L5 and L6 in contact. When the bar L1 leaves the power supply brush 200, a pulse is created and is discharged in the brush 300. The difference in voltage between the brush 200 and the brush 300 is recovered in order to generate the output signal. The peak appearing on the signal Sb in FIG. 3b corresponds to the pulse generated directly by the discharge of the winding section of the armature that is connected to the bar L2 still in contact with said power supply brush 200 and with the one L1 that loses contact with said power supply brush 200.

Next, the bar L5 leaves the brush 100. The additional brush 300 is once again in contact with the power supply brush 200, owing to the following bar L2. The signal presented at Sc corresponds to the slight difference in potential existing at the ends of the winding segment including the portions 8 and 15.

A new cycle starts over again.

As can be seen, the additional brush is at least periodically in contact with the power supply brush referred to as “follow-up brush,” by way of a bar. It is also connected to an electrical circuit that includes a voltage measuring means which makes it possible to continuously know the voltage on said additional brush. The circuit is arranged in such a way that the voltage on the additional brush is known in relation to another voltage: a constant reference voltage (ground, for example) or else that of one of the power supply brushes (the follow-up brush, for example). The electrical circuit also advantageously includes a signal processing means using said voltage measured on the additional brush and making it possible to count the current pulses generated in said electrical circuit to which the additional brush is connected, in particular when the follow-up brush leaves a bar of the commutator.

The device equipping the motor according to one embodiment of the invention is simple and makes it possible to measure the angular position of the motor by counting the commutator bars. The principle followed consists in using the alternation of the different electrical signals transmitted on the additional brush and that appear, on the one hand, when the follow-up power supply brush and the additional brush are in contact by way of a bar and, on the other hand, when a bar loses contact with the follow-up brush. As a matter of fact, an overvoltage appears when a bar leaves a power supply brush. This overvoltage involves a current pulse generated in the electrical circuit to which the additional brush is connected. It is this current pulse, for example, which, after transformation, filtering and conversion, makes it possible to count the bars of the commutator and to consequently measure the position and/or to control the speed of the motor. Within the framework of this invention, the power supply brush is referred to as the “follow-up brush,” since an additional brush is assigned to it, which is placed in proximity thereto and which, when associated with a measuring circuit, makes it possible to continuously follow the electrical signals transmitted and, in particular, the pulses generated when a bar leaves the follow-up brush.

The additional brush is placed in proximity to the follow-up brush. The additional brush and the follow-up brush are distant from each other by a distance less than the width of a bar, whereby the additional brush is periodically at the same potential as the follow-up brush by means of a common bar. The additional brush can be placed after or before the latter, in relation to the direction of rotation of the motor.

When it is placed after the follow-up brush (downstream), a commutator bar first encounters the power supply brush and then the additional brush. When it leaves the follow-up brush, it is still in contact with the additional brush. The pulse corresponds substantially to the discharge of the inductance of the portion of the induced winding that is connected to the bar still in contact with the power supply brush and to the one that has just lost contact with said brush.

When it is placed before the follow-up brush (upstream), a commutator bar first encounters the additional brush and then the follow-up brush. The pulse results from the transition from a state where the two brushes are on the same bar and where the difference in potential between the brushes is consequently zero, to a state where the two brushes are on different bars and where the difference in potential between the brushes corresponds substantially to the drop in potential generated by the induced current that passes through the coil connected to the two aforesaid bars. The pulse corresponds substantially to the passing of a current through the segment of the armature that is connected to the bar still in contact with the power supply brush and with the one that has just lost contact with said brush. In this case, the signal is weaker, but remains exploitable.

The additional brush and the follow-up brush could have different widths: the follow-up brush is a power supply brush whose width must be as close as possible to that of the other power supply brush or brushes and the additional brush could be narrower since it essentially serves to collect the pulse created when a bar leaves the follow-up brush. However, according to the invention, the additional brush and the follow-up brush have a substantially equal width and are arranged symmetrically in relation to a diametral plane of the rotor, so as to be able to play interchangeable roles regardless of the direction of rotation of the motor.

The choice of the direction of rotation is easily made, e.g., with the aid of transistors or a properly connected relay. The additional brush then becomes the follow-up brush and the follow-up brush, to which the circuit including the voltage measuring means and the signal processing means is also connected, becomes the additional brush. The two brushes are then simultaneously connected to the power supply and to the measuring and signal processing circuit, so that the system can be reversible (operation in both directions of rotation). In a configuration such as this, the measuring and signal processing circuit connects the follow-up brush and the additional brush, which for this reason is electrically uninsulated permanently.

Furthermore, a configuration such as this improves the electromagnetic compatibility of the motor, in particular when the additional brush is placed downstream from the follow-up brush (i.e., after it in the direction of rotation). The follow-up brush and the additional brush are connected by said electrical circuit and, when the follow-up brush leaves a bar, which however remains in contact with the additional brush, a portion of the discharge current of the winding associated with these two bars is diverted towards this electrical circuit, which reduces the amplitude of the overvoltage.

According to an exemplary embodiment of the invention, the additional brush and the follow-up brush have a substantially equal width. The latter must be sufficient enough for the brushes to resist wear as well as the other brushes. However, it is recommended that the overall width of the assembly formed by the additional brush and the follow-up brush not be too significant, because the efficiency of the motor decreases with the number of segments of the winding that are short-circuited, and this is all the more significant to the extent that the follow-up brush and additional brush are wider. As much as possible, an overall width is sought for the assembly formed by the additional brush and follow-up brush which is as close as possible to the width of the power supply brush or brushes. Typically, this overall width should not exceed the minimum width of the power supply brushes other than the follow-up brush (in general all of these brushes have the same width) plus the width of one bar. In this way, a maximum of two bars are short-circuited.

The space separating the follow-up brush and the additional brush must be less than the width of one bar in order for there to be shared potential and the possibility of discharge in the additional brush, at each passage of a bar, as soon as the bar leaves the power supply brush. For obvious reasons involving the overall dimensions and efficiency of the motor, the space separating the follow-up brush and the additional brush must be as small as possible, but sufficiently large to prevent the creation of untimely arcs between them. This distance depends, in particular, on the material used for the brushes and the insulation used (air, paper, plastic, etc.) and can vary between a few hundredths of a millimetre and a few millimetres. Typically, it is a few tenths of a millimetre for a 12-volt direct-current motor.

The additional brush is electrically connected to a voltage measuring means and to an electrical signal processing means. The electrical signal to be processed is constructed from the voltage on the additional brush. For example, as a signal, it is possible to take the difference in potential between the additional brush and ground. But, preferably, the additional brush and the follow-up brush being usable interchangeably, regardless of the direction of rotation of the motor, the processed and transformed signal uses the difference in potential between the follow-up brush and the additional brush.

The number and spatial arrangement of the brushes depends on the multipolarity of the electric motor. The invention can be applied to any type of multipolar direct-current motor, typically with 2, 4 or 6 poles, whether it involves a small motor placed on board a motor vehicle or a rolling mill motor. The invention will be illustrated below by one particular embodiment: a bipolar direct-current motor, representative of motors for equipment placed on board motor vehicles.

In such a motor, the power supply brushes are conventionally arranged along the circumference of the motor so that they are diametrically opposite one another. This arrangement enables a systematic distribution of the currents on each of the coil winding paths. The neutral line of the motor corresponds to the boundary between these areas, i.e., to the diametrically opposite locations where the magnetic polarity changes signs. It is at this location that the current must be reversed and the brushes must be placed as close as possible to the neutral line.

The bipolar direct-current motor produced according to this embodiment of the invention has an additional brush and a follow-up brush that are symmetrical in relation to the diametral plane of the rotor, the latter coinciding with the plane of symmetry of the other power supply brush. In this preferred embodiment, the width of the power supply brush or, more generally speaking, the maximum width of the power supply brushes other than the follow-up brush, and the overall width of the group consisting of the follow-up brush and the additional brush, is less than the width of one bar plus two interbars (spaces separating the bars).

If the additional brush is placed downstream from the follow-up brush and if a bar leaves the follow-up brush, a discharge current appears in the winding segment of the armature that is connected to the bar still in contact with the follow-up brush and with the one that has lost contact with said follow-up brush. This results in an abrupt variation in voltage on the additional brush, and consequently in an abrupt variation in the difference in potential between the additional brush and the follow-up brush. However, the follow-up brush and the additional brush being connected by a resistive circuit, the electromagnetic disturbances of the motor are lessened.

If the additional brush is placed upstream from the follow-up brush and if a bar leaves the follow-up brush, a pulse of weaker amplitude is picked up in the measuring circuit. The ripples picked up are sufficient to enable counting of the bars, after filtration and conversion.

Another embodiment of the invention is a method for controlling the angular position and rotational speed of the rotor of a commutator motor, typically a direct-current motor, consisting in counting the number of bars of the commutator passing in front of a fixed point, characterised in that the fixed point chosen is one of the power supply brushes, referred to as a follow-up brush, in that an additional brush is placed in proximity to said follow-up brush, at a distance less than the width of one bar and in that the voltage on said additional brush is measured continuously. In order to carry out this measurement continuously, the additional brush is connected to a circuit including at least one voltage measuring means and one electrical signal processing means using said voltage. The signal is processed in such a way that it is possible to count the pulses generated each time a bar of the commutator leaves the follow-up brush.

The additional brush can be placed after or before the follow-up brush, in relation to the direction of rotation of the motor. If the additional brush is placed downstream from the follow-up brush and if a bar leaves the follow-up brush, a discharge current appears in the segment of the armature that is connected to the bar still in contact with said follow-up brush and with the one that loses contact with said follow-up brush.

The processing means is advantageously an electronic circuit that uses the continuously measured voltage on the additional brush in order to generate a signal, and that makes it possible to transform, filter and convert said signal into a squarewave signal. In this way, it makes it possible to count the bars of the commutator and to consequently control the angular position of the motor and/or its rotational speed.

According to another exemplary embodiment of the invention, the additional brush and the follow-up brush have a substantially equal width and are arranged symmetrically in relation to a diametral plane of the rotor, so as to be able to play interchangeable roles regardless of the direction of rotation of the motor.

The signal collected on the additional brush is compared to the power supply voltage of the follow-up brush. In this way, the difference in potential between the follow-up brush and the additional brush is measured. This difference in potential is then filtered so as to eliminate the high-frequency disturbances therefrom. An operational amplifier-based comparator can be used to generate a squarewave signal. The filtering of the signal, as well as the reference voltage for switching the operational amplifier, and consequently the creation of the squarewave signal, are determined with respect to the motor. This choice makes it possible to operate the system even when the motor stops, i.e., when it is no longer powered but still driven in rotation by its inertia.

It is possible, for example, to filter only the high frequencies superimposed over the signal or to filter the signal so as to have nothing more than the fundamental frequency thereof. These means are easy to implement and it is very easy to generate a squarewave signal from these means. Furthermore, it is easily possible to imagine the implementation of any system making it possible to modify the cyclic ratio, amplitude, etc., of the squarewave signal.

The reference voltage for switching the operational amplifier is, for example, created from the signal itself, by filtering it. This operation enables operation of the system even when the motor stops. Consequently, it would be possible to measure the position of a motor operating as a generator. Finally, a monostable assembly can possibly be added in order to regulate the cyclic ratio of the squarewave signal generated.

Another embodiment of the invention is a device for controlling the angular position and rotational speed of the commutator motor, including brush-holders equipped with brushes capable of being connected to an outside electrical circuit and including an additional brush, characterised in that said additional brush is placed next to one of said brushes capable of being connected to an outside electrical circuit, referred to as a follow-up brush, at a distance less than the width of one bar of the commutator of said motor and in that said additional brush is connected to an electrical circuit including a voltage measuring means and an electrical signal processing means using the voltage thus measured and making it possible to count the pulses generated when a bar leaves the follow-up brush.

The brushes capable of being connected to an outside electrical circuit are generally the power supply brushes capable of being connected to the power supply circuit. But, as will be seen further on, the system can operate in the same way when the motor is not powered, i.e., when it operates as a generator. In this case, the outside circuit can be an electrical circuit powered by the generator.

The additional brush can be placed after or before the follow-up brush, in relation to the direction of rotation of the rotor. If the additional brush is placed downstream from the follow-up brush and if a bar leaves the follow-up brush, a discharge current appears in the segment of the armature that is connected to the bar still in contact with said follow-up brush and with the one that loses contact with said follow-up brush.

The additional brush is connected to an electrical circuit that includes a voltage measuring means and an electrical signal processing means, typically an electronic circuit, using the measured voltage and making it possible to count the pulses generated when a bar leaves the follow-up brush. With the aid of an appropriate electronic circuit, the pulses are shaped, filtered and converted so as to be able to count the bars of the commutator.

According to an embodiment of the invention, the additional brush and the follow-up brush have a substantially equal width and are arranged symmetrically in relation to a diametral plane of the rotor, so as to be able to play interchangeable roles, regardless of the direction of rotation of the motor. The device enabling reversal of the direction of rotation can be made very simply, for example, from transistors or relays.

The electronic circuit makes it possible to process the signal collected on the additional brush by comparing the latter to the power supply voltage of the follow-up brush. In this way, the difference in potential between the follow-up brush and the additional brush is measured and this difference in potential is then filtered so as to eliminate the high-frequency disturbances therefrom. The filtering of the signal, as well as the reference voltage for switching the operational amplifier, and consequently the creation of the squarewave signal, are determined with respect to the electric motor concerned.

This electronic circuit must be able to be operational regardless of the direction of rotation of the motor. The solutions currently used for reversing the direction of rotation of the motor can be applied, only the wiring for the transistors or relays is modified slightly, which does not involve any additional production cost.

Using a device such as this, the system can be operated even when the motor stops, i.e., when it is no longer powered, but still driven in rotation by its inertia. It is therefore also possible to control the angular position of the rotor when the motor operates as a generator, i.e., when, in the absence of a power supply and if the rotor is driven in rotation, this system also makes it possible to count the pulses generated by the passing of the bars. A device such as this can thus be used in displacement transducers, for example.

Thus, it should be understood that the embodiments and examples have been chosen and described in order to best illustrate the principles of the invention and its practical applications to thereby enable one of ordinary skill in the art to best utilize the invention in various embodiments and with various modifications as are suited for the particular uses contemplated. Even though specific embodiments of this invention have been described, they are not to be taken as exhaustive. There are several variations that will be apparent to those skilled in the art. Accordingly, it is intended that the scope of the invention be defined by the claims appended hereto.

1-15. (canceled)

16. An electric commutator motor, comprising:
a frame comprising a stator and a first and at least one additional power supply brushes;
a rotor disposed proximate to said stator;
a commutator integral with said rotor, said commutator comprising a plurality of bars;
a set of coiled loops whose ends are connected to successive bars of said commutator; and
at least one additional brush disposed adjacent to the first power supply brush at a distance less than the width of a bar, said additional brush being connected to an electrical circuit, said electrical circuit comprising electrical voltage measuring means,
wherein said additional brush is approximately equal in width to the first power supply brush, and the additional brush and first power supply brush are arranged symmetrically in relation to a diametral plane of the rotor.

17. The electric commutator motor of claim 16, further wherein the electrical voltage measuring means is adapted to continuously measure the voltage on said additional brush, and the electrical circuit further comprises signal processing means adapted to count current pulses generated in said electrical circuit.

18. The electric commutator motor of claim 17, further wherein the signal processing means counts current pulses generated in said electrical circuit when the first power supply brush leaves a bar of the commutator.

19. The electric commutator motor of claim 16, wherein the additional brush is disposed behind the first power supply brush with regard to the direction of rotation of the motor.

20. The electric commutator motor of claim 16, wherein the additional brush is disposed in front of the first power supply brush with regard to the direction of rotation of the motor.

21. The electric commutator motor of claim 16, wherein said first power supply brush is equal in width to any additional power supply brushes.

22. The electric commutator motor of claim 16, wherein the overall width of the assembly formed by the first power supply brush and the additional brush does not exceed the width of an additional power supply brush plus the width of one bar.

23. The electric commutator motor of claim 16, wherein the width of an additional power supply brush plus the overall width of the assembly formed by the first power supply brush and the additional brush is less than the width of a bar plus two times the space between two adjacent bars.

24. The electric commutator motor of claim 16, wherein the electrical circuit is connected to the first power supply brush, the difference in potential between the first power supply brush and the additional brush is measured by the electrical voltage measuring means.

25. The electric commutator motor of claim 17, wherein the signal processing means comprises an electronic circuit that generates a signal based on the continuously measured voltage on the additional brush.

26. The electric commutator motor of claim 25, further comprising means to transform, filter and convert said signal into a squarewave signal.

27. The electric commutator motor of claim 26, wherein said means to transform, filter and convert said signal into a squarewave signal comprises an operational amplifier-based comparator assembly, wherein a reference voltage is created from an average value or a filtering of the signal.

28. A method for controlling the angular position of the rotor of a commutator motor, comprising the steps of:
counting the number of bars of a commutator passing a fixed point, wherein the fixed point is a first power supply brush;
further wherein an additional brush is disposed adjacent to the first power supply brush at a distance less than the width of a bar, the voltage on said additional brush being continuously measured; and
further wherein said additional brush is approximately equal in width to the first power supply brush, and the additional brush and first power supply brush are arranged symmetrically in relation to a diametral plane of the rotor.

29. The method of claim 28, wherein the additional brush and first power supply brush both are connected to a power supply so as to play interchangeable roles, regardless of the direction of rotation of the motor.

30. The method of claim 28, wherein said additional brush is connected to an electrical circuit, said electrical circuit comprising voltage measuring means adapted to measure the voltage on said additional brush and electrical signal processing means adapted to use said measured voltage to count the pulses generated each time a bar of the commutator leaves the first power supply brush.

31. The method of claim 28, further comprising the steps of:
measuring the difference in potential between said additional brush and said first power supply brush; and
filtering the difference in potential to eliminate high-frequency disturbances therein.

32. The method of claim 28, further comprising the steps of:
generating a squarewave signal from a comparator assembly, wherein a reference voltage is created from an average value or a filtering of the signal.

33. The method of claim 32, wherein the comparator assembly is an operational amplifier-based comparator assembly.

34. A device for controlling the angular position and rotational speed of a commutator motor or generator with bars, comprising:
a first power supply brush; and
at least one additional brush disposed adjacent to the first power supply brush at a distance less than the width of a bar, said additional brush being connected to an electrical circuit, said electrical circuit comprising voltage measuring means adapted to measure the voltage on said additional brush and electrical signal processing means adapted to use said measured voltage to count the pulses generated each time a bar of the commutator leaves the first power supply brush;
further wherein said additional brush is approximately equal in width to the first power supply brush, and the additional brush and first power supply brush are arranged symmetrically in relation to a diametral plane of the rotor.

35. The device of claim 34, wherein the additional brush and first power supply brush both are connected to a power supply so as to play interchangeable roles, regardless of the direction of rotation of the motor.
